(19) United States
(12) Patent Application Publication
(10) Pub. No.: US 2023/0236135 A1
(43) Pub. Date: Jul. 27, 2023

(54) Tank Inspection Systems and Methods

(71) Applicant: USTANX, LLC, Maryville, TN (US)

(72) Inventor: Jared Brian Douglas, Maryville, TN (US)

(73) Assignee: USTANX, LLC, Maryville, TN (US)

(21) Appl. No.: 17/586,346

(22) Filed: Jan. 27, 2022

(51) Int. Cl. G01N 21/954

(52) U.S. Cl. CPC G01N 21/954

(57) ABSTRACT

A tank inspection system of the present disclosure has a mounting cylinder with at least one bearing and the bearing is fixedly coupled to the mounting cylinder via at least one bearing tube. Mounted to a top of the mounting cylinder is an outer tube hand wheel and within the outer tube hand wheel is an inner rod hand wheel. Also, the system has an outer tube that is fixedly coupled to the outer tube hand wheel of the mounting cylinder such that when the outer tube hand wheel rotates, the outer tube rotates. Additionally, the system has an inner tube moveable coupled to the inside of the outer tube and fixedly coupled to the inner hand wheel such that when the inner hand wheel rotates the inner tube rotates. Furthermore, the system has a movement head disposed at a bottom of the outer tube and the inner tube, the inner tube is moveably coupled to a drive gear, which is moveably coupled to a lateral gear such than when the inner rod rotates, the drive gear rotates thereby rotating the lateral gear, the lateral gear is fixed coupled to a shaft on which is mounted a device, so that when the inner rod is rotated via the inner rod hand wheel, the device moves in an up and down fashion, the outer rod is fixedly coupled to the movement head so that when the outer hand wheel is rotated, the device moves in a circular fashion 360°.

### BACKGROUND

Oftentimes, fuel or flammable material is stored underground. For example, at a gas station, fuel used to fill vehicles is stored underground. These types of tanks are static. They do not move. They are permanently affixed underground to supply the fuel. When fuel in the tank runs low, a fuel truck fills the tank through a conduit in the ground that accesses the fuel tank.

Typically, tanks may be inspected in any number of ways. For example, a tank may be inspected by visually investigating the exterior of the tank. However, this type of inspection is not practical for fuel tanks that are permanently affixed underground.

One may also check for external pitting and corrosion. Again, this type of inspection is not practical for fuel tanks that are permanently affixed underground.

Further, one may look for noticeable distortions, buckling, denting, or bulging on the outside of the tank. However, this type of inspection is not feasible with underground tanks.

### BRIEF DESCRIPTION OF THE DRAWINGS

The present disclosure can be better understood with reference to the following drawing figures. The elements of the drawing figures are not necessarily to scale relative to each other, emphasis instead being placed upon clearly illustrating the principles of the disclosure. Furthermore, like reference numerals designate corresponding parts throughout the several views.

FIG. 1 is a perspective view of a tank inspection system in accordance with an embodiment of the present disclosure.

FIG. 2 is an exploded, perspective view of the tank inspection system as is shown in FIG. 1.

FIG. 3 is a perspective view of an exemplary top stage of the tank inspection system as is shown in FIG. 1.

FIG. 4 is a perspective view of the exemplary top stage as is shown in FIG. 3 further comprising an exemplary mounting cylinder.

FIG. 5 is a perspective view of an exemplary middle stage of the tank inspection system as is shown in FIG. 1.

FIG. 6 is a perspective view of a portion of the middle stage of the tank inspection system as is shown in FIG. 1.

FIG. 7 is a perspective view of an exemplary bottom stage of the tank inspection system as is shown in FIG. 1.

FIG. 8 is an exploded view of an exemplary housing that is coupled at the end of the bottom stage of the tank inspection system as is shown in FIG. 1.

### DETAILED DESCRIPTION

The present disclosure is an embodiment of a tank inspection system. The tank inspection system of the present disclosure is used to internally inspect a tank that is underground. The tank can be any type of tank known in the art or future-developed. The tank inspection system of the present disclosure may be used on any type of tank storing liquid or gas wherein the tank is underground.

The tank inspection system of the present disclosure comprises three stages. The top stage comprises a mounting cylinder and a large bearing tube. Coupled to the mounting tube is an outer tube that extends downward to a movement head at the end of the outer tube. The top stage further comprises an inner hand wheel and an outer hand wheel. The outer hand wheel, when actuated, rotates the outer tube at 360°. Furthermore, the inner hand wheel moves an inner rod, which translates into pitch up or down of a device coupled to the final stage. In one embodiment, the device is a camera.

The tank inspection system of the present disclosure further comprises a middle stage. The middle stage comprises at least one inner rod and an outer tube moveably coupled to the inner tube via bearings. The inner rod, when actuated by the inner hand wheel, moves the device pitch up or down. The outer hand wheel, when actuated, moves the outer tube thereby rotating the device up to 360°.

The tank inspection system of the present disclosure further comprises a final stage. The final stage comprises an outer tube, and moveably coupled to the outer tube is an inner rod via bearings. Further, the outer tube is fixedly coupled to the movement head. Also, the inner rod is moveably coupled to the device. Thus, the outer tube, when actuated by the outer hand wheel, moves the device around 360°. However, when the inner rod is actuated by the inner hand wheel, the device moves pitch up or down.

Therefore, the tank inspection system, when inserted into a tank, can inspect the integrity of the inside of the tank. That is, the camera may be mounted to final stage. When a user actuates the outer hand wheel, the camera rotates around 360° giving the user a plan view of the inside of the tank. When a user actuates the inner hand wheel, the camera rotates pitch up or down giving the user an upward view of the tank and and/or downward view of the tank.

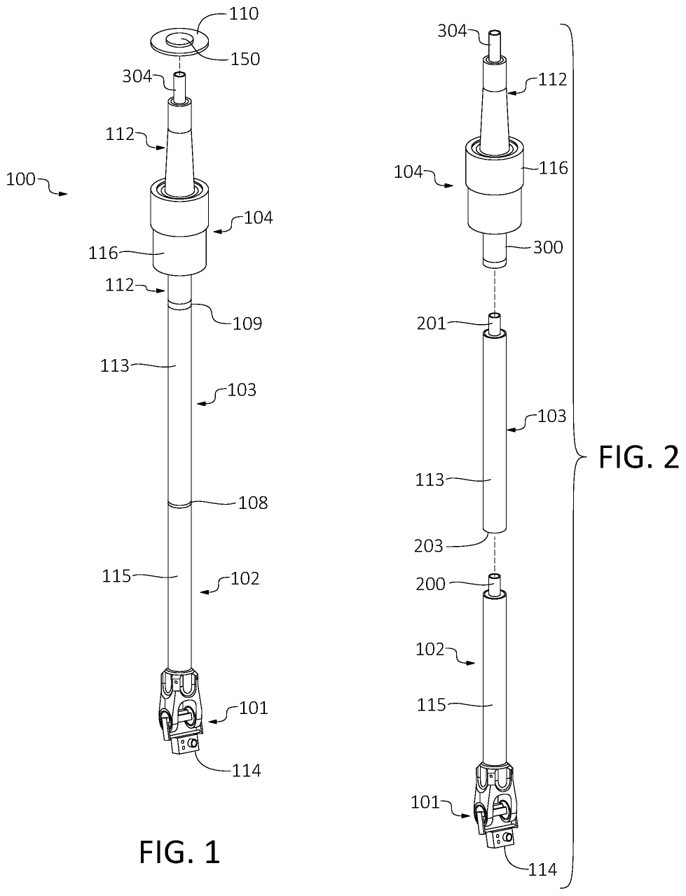

FIG. 1 is a tank inspection system 100 in accordance with an embodiment of the present disclosure. The tank inspection system 100 comprises a top stage 104, a middle stage 103, and a final stage 102.

The top stage 104 comprises an inner rod 304, a mounting cylinder 112, an inner hand wheel 150, and an outer hand wheel 110. The outer hand wheel 110 is fixedly coupled to the mounting cylinder 112 such that when the outer hand wheel 110 is rotated, the mounting cylinder 112 and outer tubes 113 and 115 rotate 360°. When the outer tube sections 113, and 115 rotate, a device 114, e.g., a camera, at an end of the tank inspection system 100 rotates 360°.

The inner hand wheel 150 is fixedly coupled to an inner rod 304. That is, the inner rod 304 is inside the mounting cylinder 112. Furthermore, there are a plurality of inner rods (not shown) to which the inner rod 304 is coupled. Also, the inner rod 304 is fixedly coupled to the inner hand wheel 150. When the inner hand wheel 150 is actuated, a device 114, e.g., a camera, coupled to a movement head 101 moves upward and downward based on the rotational movement of the inner wheel 150. Note that the rotation of the inner rod 304 is translated into pitch up and down motion in the device 114, which is described further herein.

The tank inspection system 100 further comprises a middle stage 103. The middle stage 103 comprises the outer tube 113. Within the outer tube 113 is an inner rod (not shown). The middle stage 103 fixedly couples to the top stage 104 by the inner rod and the outer tube 113. In one embodiment, the inner rod is threaded, and the inner rod is threadedly coupled to the inner rod 304.

Note that FIG. 1 shows one middle stage 103. However, additional middle stage hardware may be coupled to the middle stage 103 to lengthen the tank inspection system 100. That is, the number of middle stages 103 used in the tank inspection system 100 depends upon the depth of the tank that a user is inspecting.

The tank inspection system 100 further comprises a final stage 102. The final stage 102 comprises an outer tube 115, a movement head 101, and a device, e.g., camera 114, coupled to the movement head 101.

In operation, a user lowers the tank inspection system 100 into an opening in a tank (not shown). Once the tank inspection system 100 is lowered into the tank, the user may inspect the internalities of the tank. In this regard, the user may turn the outer wheel handle 110 to rotate the device 114 360°, e.g., a camera. Further, the user may turn the inner wheel handle 150 and move the camera pitch upwards and downwards. In this regard, the user can examine the internalities of the tank under inspection.

FIG. 2 is an exploded view of the tank inspection system 100 of the present disclosure. The tank inspection system 100 comprises the top stage 104, the middle stage 103, and the final stage 102, as described above.

The top stage comprises the top rod 112 and the mounting cylinder 116. The mounting cylinder 116 shall be described further herein. The top rod 112 is fixedly coupled to the outer tube 113 and the inner rod 304 is fixedly coupled to an inner rod 201 that extends from the outer tube 113. As noted above, the inner rod 201 may comprise threads, and the inner rod 201 is screwed onto an inner opening in the top stage 104. Thus, top rod 112 forms with the outer tube 113.

The middle stage 103 comprises the outer tube 113. Within the outer tube 113 is an inner rod 201. As noted above, the inner rod 201 may comprise threads so that it may be screwed to an opening in the top stage 104.

The inner rod 201 runs almost the length of the outer tube 113. However, at a bottom of the outer tube 113 there is an opening 203. The inner rod 200 is sunken in slightly to the outer tube 113. The opening provides access by an inner rod, e.g., inner rod 200, to fixedly couple to the inner rod 201. In this regard, the inner rod 201 may comprise threads, and the inner rod 201 may be screwed to the inner rod 201. Note that when the inner rod 201 is fixedly coupled to the top stage 104 and the inner rod 200 is fixedly coupled to the middle stage 103, the outer tubes 112, 113, and 115 are coupled together.

The final stage 102 comprises the outer tube 115, the inner rod 200, a mounting head 101, and a device 114 mounted to the mounting head 101, e.g., a camera. The outer tube 115 is fixedly coupled to the mounting head 101. Further, the inner rod 200 is coupled to a gear (not shown) that translates rotational movement into pitch up and down movement of the device 114. This is discussed further herein.

In operation, the user rotates the outer wheel handle 110. When the outer wheel handle 110 is rotated, the mounting head 101 rotates 360°. When the inner wheel handle 110 is rotated, the inner rod 200 rotates, thereby rotating the gear, and the rotational movement of the gear is translated into pitch up and down motion of the device 114. Movement of the movement head 101 and the gear allows the user to investigate the internalities of the tank (not shown).

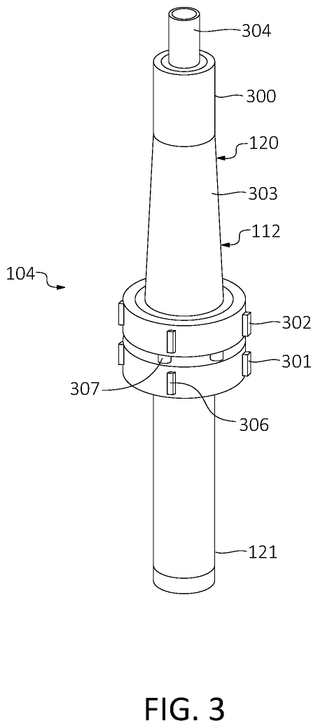

FIG. 3 is a perspective view of the top stage 104. Note that the top stage 104 supports the weight of the tank inspection system 100. Further, the top stage 104 allows rotation of the outer tube 113 (FIG. 1) and 115 (FIG. 1) of the tank inspection system 100. Further, the top stage 104 allows rotation of the inner rod 304, the inner rod 201 (FIG. 1), and the inner rod 200 (FIG. 1).

The top stage 104 comprises the rod 112. Coupled to the top rod 112 are bearings 301 and 302. The bearings 301 and 302 lock into place on the rod 112 and allow the outer tube 113 (FIG. 1) and 115 (FIG. 1) to rotate. Further, the bearings 301 and 302 hold the entire weight of the tank inspection system 100. Thus, the bearings 301 and 302 are machined into the same piece of material that the mounting cylinder 116 (FIG. 1) is made from. In one embodiment, they have a 5-inch diameter that exceeds the 4-inch diameter of the rod 112. Thus, if the tank inspection system 100 is dropped before the top stage is locked in, the tank inspection system 100 would not fall into the tank.

In one embodiment, the bearings 301 and 302 comprise a plurality of extrusions 306. The extrusions 306 lock the top stage, which is described further herein. The extrusions 306 slide into identical indentations (not shown) in the mounting cylinder 116. This locks the bearings 301 and 302 into place while the outer tube 112, outer tube 113 (FIG. 1) and outer tube 115 (FIG. 1) remains free to rotate about the z-axis.

The top stage 104 further comprises support rods 307 placed between the two bearings. The rods 307 allow the extrusions 306 to rotate colinear with each other. Thus, it is easier to lock the mounting cylinder 116 into the top rod 112. Further, the support rods 307 allow the force load on the bearings 301 and 302 from the tank inspection system 100 to be shared between both bearings. Without the support rods 307, all the load force would be on the bottom bearing.

Note that an inner rod 304 protrudes from the top rod 112. The inner rod 304 comprises threads. Thus, the inner rod 304 is threadedly coupled to the inner wheel handle 110. When the inner wheel handle 110 is actuated, the inner rod 304, inner rod 201 (FIG. 2) and inner rod 200 (FIG. 2) rotate thereby actuating the device 114 pitch up and down.

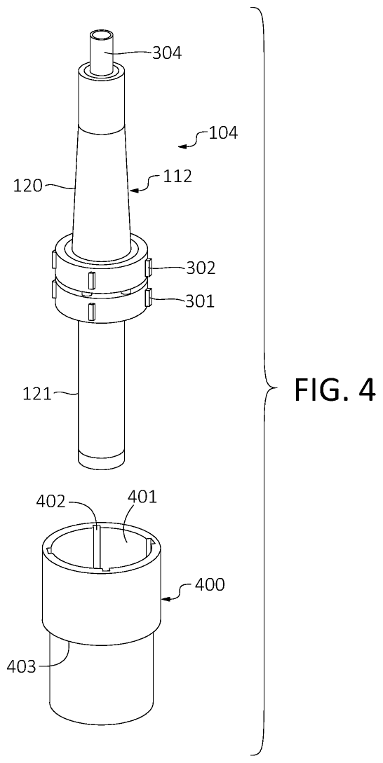

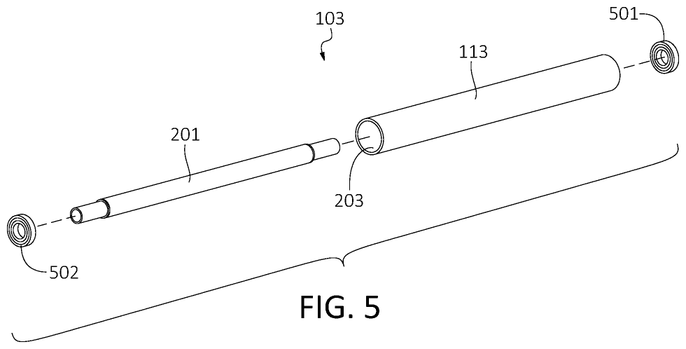

FIG. 4 is an exploded view of the top stage 104 of the tank inspection system 100. As described above, the top stage 104 comprises an inner rod 304 that protrudes from the upper section 120 of the outer tube 112. The rod 304 extends through the upper section 120 to an opening in the lower section 121. Coupled thereto are bearings 301 and 302.

The top stage 104 comprises the mounting cylinder 400. The mounting cylinder 400 couples to the outer tube 112. The top portion of stage 104 is inserted in the mounting cylinder 400 until the bearings 301 and 302 lock in place.

The mounting cylinder 400 comprises one or more extrusions 402. The extrusions 402 are configured to be received by the protrusions 306 (FIG. 3). When the bearings 301 and 302 slide into the protrusions 306, the system 100 locks in place.

The mounting cylinder 400 further comprises a lip 403. At the lip 403 the mounting cylinder 400 inner diameter of the cylinder goes from 5 inches to 4 inches. The top portion of the mounting cylinder 400 is large enough for the bearings 301 and 302 to fit inside the mounting cylinder 400. Further, the bottom part of the mounting cylinder 400 is small enough to screw into the tube 112. The bearings 301 and 302 rest on a ledge created by the change in diameter to support the weight of the system 100 while it is in the tank (not shown).

FIG. 5 is an exploded view of the middle stage 103. The middle stage 103 comprises the outer tube 113, the inner tube 201, and bearings 501 and 502. The bearings 501 and 502 are moveably coupled to each end of the inner tube 201.

That is, bearing 501 fits over the top section of the inner tube 201 and the bearing 502 fits over the bottom section of inner tube 201. Note that in one embodiment the bearings 501 and 502 are 1-inch bearings. The bearings 501 and 502 ensure that the inner rod 201 can rotate separately from the outer tube 113.

The inner rod 201 is a support rod. It has a female end that is shorter than the outer rod 113 and a male end that is longer than the outer rod 113. Thus, multiple rod assemblies may be screwed to each other to lengthen the system 100.

The outer rod 113 does not have a female and male end because support is already provided from the inner rod 201. The outer rods are push coupled together so that they rotate together, but they do not hold any force.

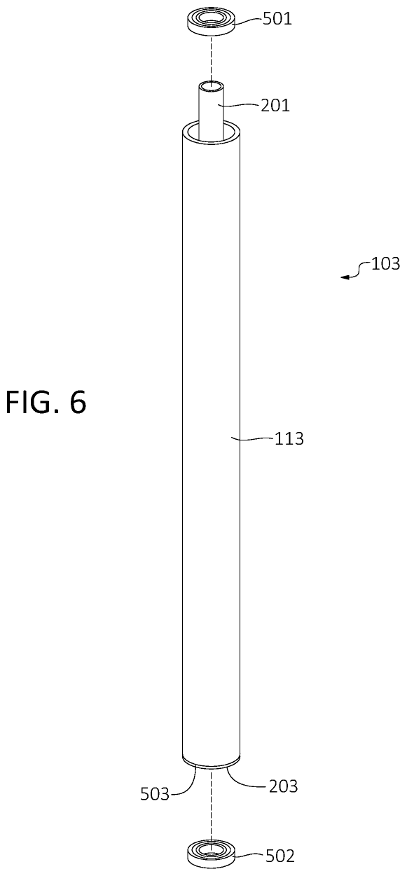

FIG. 6 is a partially exploded view of a middle stage 103. Notably, the inner rod 201 is inserted within the outer tube 113. Thus, there is a “male” end sticking out of the top of the outer tube 113. Also, there is a “female” end that is in bottom opening 503 of the outer tube 113. The bearing 501 fits over the “male” end and rests within the outer tube 113. Further, the bearing 502 fits over the “female” end (which is inside the outer tube 113). The bearings 401 and 402 enable the inner rod 201 to rotate independently from the outer tube 113.

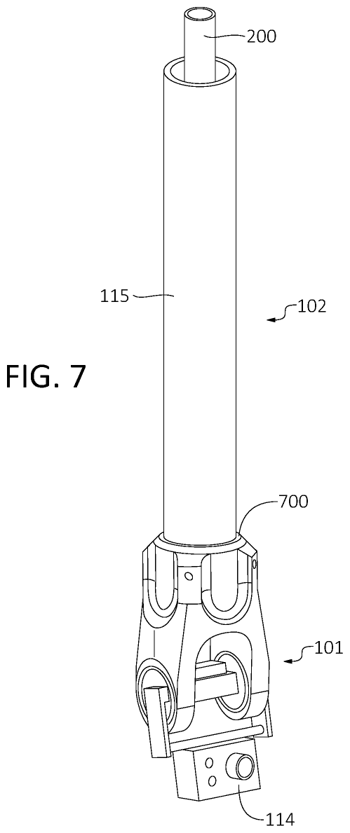

FIG. 7 is a perspective view of the final stage 102. The final stage 102 comprises the inner rod 200, outer tube 115, and a movement head 101. Attached to the movement head 101 is a device 114, e.g., a camera. Further, the movement head 101 is coupled to the outer tube 115 at seam 700.

In operation, a user rotates the inner rod 201 using an inner wheel handle 150 (FIG. 1). Rotating the inner rod 201 moves the camera 114 pitch upwards and downwards. Independent of the pitch up and down movement, movement of the outer tube 115 moves the device 114, e.g., a camera, 360°. Thus, the camera 114 images the internalities of the tank (not shown) under inspection.

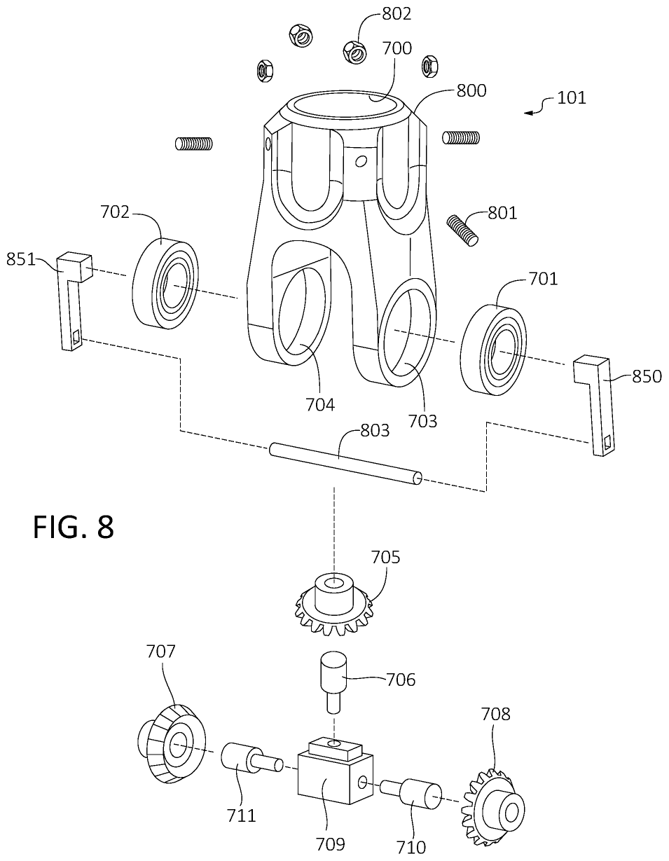

FIG. 8 is an exploded view of the movement head 101. The movement head 101 has a frame 800. The frame 800 comprises lateral circular openings 703 and 704 that are aligned.

The outer tube 115 (FIG. 7) fixedly couples to the frame 800 along seam 700. In this regard, there are a plurality of screws 801 and a plurality of bolts 802 that fixedly couple the outer tube 115 to the movement head 101. Because the outer tube 115 is fixedly coupled to the frame 800, when the outer tube 115 rotates the frame 800 rotates thereby rotating the device 114 (FIG. 7) that is affixed to the frame 800. Note that the fasteners allow the system to rotate axially around the z-axis. Further, it gives support to the system of bearings and gears shown in FIG. 8

Fitted within the openings 703 and 704 are bearings 701 and 702, respectively. The bearings 701 and 702 attach around gears 708 and 707, respectively. Gears 708 and 707 are turned by a drive gear 705. T-Connector 709 receives the shafts 706 and 710. The end of the shaft that connects to the T-connector 709 is fixed with a bearing that allows it to rotate axially.

Gear 705 is the driving gear. Gear 705 is moved by the inner rod 201 (FIG. 5). The gear 705 allows movement of the system in the arc through the y and z plane. That is, the camera 114 moves pitch up and down through the gear 705.

Gear 707 couples to shaft 711. Gear 707 stabilizes and supports the system. In one embodiment, that is its only purpose. However, it may be used in other embodiments of the present disclosure.

Shaft 706 couples the driving gear 705 to the t-connector 709. Such that when the driving gear 705 rotates, the gear 708 rotates. When gear 708 rotates, a shaft 803 holding the device 114 (FIG. 1), e.g., camera or light, rotates pitch up and down. Note that any type of device may be coupled to the shaft 890 depending upon what may be needed to inspect a tank.

The frame 800 further comprises connecting L-bars 851 and 850. The L-bars 851 and 850 couple to the shaft 803 and transfer motion from the gear 705 and gear 708 to the shaft 803. Thus, the shaft 803 turns axially and moves the device 114, e.g., camera or light, pitch up and down.

Bearing 701 and bearing 702 attached inside of the frame 101 and around gears 708 and 707. This allows the gears 708 and 707 to rotate freely while still being supported.

What we claim is:

1. A tank inspection system, comprising:
a mounting cylinder comprising at least one bearing and the bearing is fixedly coupled to the mounting cylinder via at least one bearing tube, mounted to a top of the mounting cylinder is an outer tube hand wheel and within the outer tube hand wheel is an inner rod hand wheel;
an outer tube that is fixedly coupled to the outer tube hand wheel of the mounting cylinder such that when the outer tube hand wheel rotates, the outer tube rotates;
an inner tube moveable coupled to the inside of the outer tube and fixedly coupled to the inner hand wheel such that when the inner hand wheel rotates the inner tube rotates;
a movement head disposed at a bottom of the outer tube and the inner tube, the inner tube is moveably coupled to a drive gear, which is moveably coupled to a lateral gear such than when the inner rod rotates, the drive gear rotates thereby rotating the lateral gear, the lateral gear is fixed coupled to a shaft on which is mounted a device, so that when the inner rod is rotated via the inner rod hand wheel, the device moves in an up and down fashion, the outer rod is fixedly coupled to the movement head so that when the outer hand wheel is rotated, the device moves in a circular fashion 360°.

2. The tank inspection system of claim 1, wherein the mounting cylinder is coupled to the bearing tube via two bearings and the two bearings lock in place thereby allowing the outer tube to rotate.

3. The tank inspection system of claim 2, wherein the two bearings hold the weight of the tank inspection system

4. The tank inspection system of claim 3, wherein the two bearings are machined into the same piece of material that the tube of the mounting cylinder is made from.

5. The tank inspection system of claim 2, wherein the two bearings comprise lateral extrusions.

6. The tank inspection system of claim 5, wherein the lateral extrusions are configured to lock the bearings while the outer tube remains free to rotate about a z-axis.

7. The tank inspection system of claim 6, further comprising support rods that are between the bearings.

8. The tank inspection system of claim 7 wherein the support rods allow the extrusions to rotate colinear with each other.

9. The tank inspection system of claim 8, wherein the support rods allow the force of a load on the bearings to be shared between both bearings.

10. The tank inspection system of claim 1, wherein the bearing tube comprises grooves on an inner surface of the bearing tube for receiving extrusions on the at least one bearing.

11. The tank inspection system of claim 1, wherein the bearing tube has a top diameter that is larger than a lower diameter.

12. The tank inspection system of claim 11, wherein a lip is formed inside the bearing tube between the top diameter and the lower diameter.

13. The tank inspection system of claim 12, wherein the at least one bearing rests on the lip.

14. The tank inspection system of claim 12, wherein the lower diameter is fastened to the mounting cylinder.

15. The tank inspection system of claim 1, wherein the mounting cylinder is coupled to an end of the middle section and a lower section is coupled to an opposing end of the middle section and is coupled to the movement head at an end of the tank inspection system.

16. The tank inspection system of claim 15, wherein a first middle section inner rod protrudes from the middle section and screws into a mounting cylinder inner rod.

17. The tank inspection system of claim 16, wherein a lower section inner rod protrudes from the lower section and screws into the middle section inner rod.

18. The tank inspection system of claim 17, further comprising a second middle section.

19. The tank inspection system of claim 18, wherein a second middle section inner rod protrudes from the second middle section screws into the first middle section inner rod.

20. The tank inspection system of claim 18 comprising two or more middle sections to extend the tank inspection system so that the tank inspection system can be used on tanks having different depths.

21. The tank inspection system of claim 17, further comprising a bearing that fits on the middle section inner rod between the middle section inner rod and the outer tube so that the middle section inner rod can rotate freely.

22. The tank inspection system of claim 21, further comprising a bearing that fits on the opposing end of the middle section thereby allowing the middle section inner rod to rotate freely.
